(19) United States
(12) Patent Application Publication
(10) Pub. No.: US 2014/0325854 A1
(43) Pub. Date: Nov. 6, 2014

(54) HAND TOOL MACHINE

(71) Applicant: Robert Bosch GmbH, Stuttgart (DE)

(72) Inventors: Andre Hoffmann, Riedholz (CH); Michael Laett, Solothurn (CH)

(73) Assignee: Robert Bosch GmbH, Stuttgart (DE)

(21) Appl. No.: 14/264,495

(22) Filed: Apr. 29, 2014

(30) Foreign Application Priority Data
May 3, 2013 (DE) 10 2013 208 132.4

(51) Int. Cl. B23D 51/16; B23B 31/24

(52) U.S. Cl. CPC B23D 51/16; B23B 31/24; B23B 2231/00; B23B 2270/022
USPC 30/392; 279/134

(57) ABSTRACT

A hand tool machine includes a tool receiving device configured to receive an application tool. The tool receiving device is allocated a mechanically actuated locking element in order to lock the application tool in the tool receiving device. The hand tool machine also includes an electric actuator system configured to mechanically actuate the locking element.

This application claims priority under 35 U.S.C. §119 to patent application number DE 10 2013 208 132.4, filed on May 3, 2013 in Germany, the disclosure of which is incorporated herein by reference in its entirety.

### BACKGROUND

The present disclosure relates to a hand tool machine having a tool receiving device for receiving an application tool, wherein the tool receiving device is allocated a mechanically actuated locking element for the purpose of locking the application tool in the hand tool device.

A hand tool machine of this type that is embodied in a similar manner to a so-called semi-autonomous jig saw and comprises an allocated tool receiving device for a saw blade is known from the prior art. The tool receiving device is embodied in such a manner as to be able to pivot about its vertical axis by means of an actuator, wherein the actuator is controlled for example by signals from an optoelectronic system that ascertains the progression of a marker line that has been previously marked out on an allocated workpiece. As a consequence, the saw blade can constantly align itself in a semi-autonomous manner, i.e. automatically, according to the progression of the marker line so that a corresponding saw cut can be performed by an operator more easily and with a higher degree of accuracy.

The tool receiving device can be equipped with a rapid clamping system for the purpose of locking and unlocking the saw blade without having to use a tool and with the aid of a mechanical operating element, such as for example a lever, a rotating head or a locking handle. In addition, a parked position of the rapid clamping system is provided, wherein the tool receiving device remains in the unlocked position after a saw blade has been removed so that subsequently a saw blade can be inserted into the tool receiving device without having to actuate the operating element once again, wherein the tool receiving device is then locked automatically.

A disadvantage of the prior art resides in the fact that in particular as a rapid clamping system of this type is unlocked, it is necessary to use both hands to operate said system in a cumbersome and complicated manner, wherein one hand fixes the saw blade and the other hand actuates the mechanical operating element. This can lead to lack of comfort on the part of an operator.

### SUMMARY

The object of the disclosure is therefore to provide a novel hand tool machine that comprises a rapid clamping system that can be operated in a simple manner and at least during a corresponding unlocking procedure can be operated in a single-handed operation.

This problem is achieved by virtue of a hand tool machine having a tool receiving device for the purpose of receiving an application tool. The tool receiving device is a mechanically actuated locking element for the purpose of locking the application tool in the tool receiving device. An electric actuator system is provided for the purpose of mechanically actuating the locking element.

Consequently, the disclosure renders it possible to provide a semiautonomous or conventional jig saw wherein it is not necessary to provide an external fully mechanical actuating element that is to be integrated into the housing in a manner which is costly with regard to the construction. As a consequence, the reciprocating drive mechanism can be constructed inter alia in a more compact manner and can be more easily encapsulated to prevent the penetration of damaging, external influences from the environment, as a consequence of which inter alia the serviceable life of the jig saw is considerably increased. In addition, overall, the jig saw is more comfortable to operate and the impression of quality of the jig saw for the operator is increased since the operator is provided with a rapid clamping system that can be actuated single-handed at least during a corresponding unlocking procedure.

In accordance with one embodiment, the electric actuator system comprises an actuator for the purpose of driving an actuating element that is embodied for the purpose of mechanically actuating the locking element.

Consequently, it can be possible to provide a simple and robust, electric actuator system.

It is preferred that the actuator is configured so as to drive the actuating element in a rotary manner.

Consequently, an uncomplicated and space-saving electric actuator system can be provided.

In accordance with one embodiment, the actuating element comprises a drive shaft that can be driven by the actuator and a sliding element that can be actuated by the drive shaft.

Consequently, an operationally reliable sliding element, for example as a type of connecting rod or a toothed ring can be provided for the purpose of actuating the locking element with a particularly high magnitude of torque.

In accordance with one embodiment, the actuator is configured so as to drive the actuating element in a linear manner.

Consequently, a stabile electric actuator system is provided.

In accordance with one development, the actuating element can be driven by means of a hydraulically operated slave cylinder, a membrane or a linear magnet.

As a result, advantages are achieved in particular when configuring the installation space of the hand tool machine, the reason being that it is only necessary to provide one hydraulic line up to the slave cylinder. The hydraulic drive can be provided by means of a pump or a master cylinder that can be arranged in a space saving manner in a suitable free space inside the housing of the hand tool machine.

It is preferred that the actuator or the linear magnet can be controlled in dependence upon an electric switching element, in particular a button or a switch.

As a consequence, it is possible to unlock the tool receiving device in a desired comfortable electric manner.

In accordance with one embodiment, a drive motor for the purpose of driving the tool receiving device is provided and the locking element can be mechanically actuated by means of the electric actuator system only when the drive motor is inactive.

As a consequence, the tool receiving device can be moved with the aid of the electric actuator system into the unlocked position and from this position back into an operating position for a normal operation. For reasons of safety, it is in addition also prevented that the tool receiving device is moved into the unlocking position while the motor is running.

According to the provision of one embodiment, the hand tool machine is embodied as a type of jig saw.

Consequently, the disclosure can also be used in a simple manner in the case of a conventional jig saw.

In accordance with one embodiment, the jig saw is a semi-autonomous jig saw, wherein the tool receiving device can rotate about a vertical axis by means of the electric actuator system in response to a signal from an optoelectronic system for the purpose of automatically aligning the application tool, which is embodied in the form of a saw blade, during the process of sawing along a marker line, which has been marked out in advance, in a predetermined angular range in a saw position.

As a consequence, an actuator that is already provided in the case of a semi-autonomous jig saw can be also be used for the purpose of rotating the saw blade simultaneously in order to move the tool receiving device into the unlocked position.

### BRIEF DESCRIPTION OF THE DRAWINGS

The disclosure is further described in the following description with reference to the exemplary embodiments illustrated in the drawings, in which:

FIG. 1 illustrates a perspective view of a hand tool machine that is embodied in accordance with one embodiment in the form of a semi-autonomous jig saw,

FIG. 2 illustrates a perspective view of a reciprocating unit of the jig saw shown in FIG. 1,

FIG. 3 illustrates a sectional view of the reciprocating unit of the jig saw shown in FIG. 1 together with a first embodiment of an electric actuator system,

FIG. 4 illustrates a schematic view of a second embodiment of an electric actuator system, and

FIG. 5 illustrates a schematic view of a third embodiment of an electric actuator system.

### DETAILED DESCRIPTION

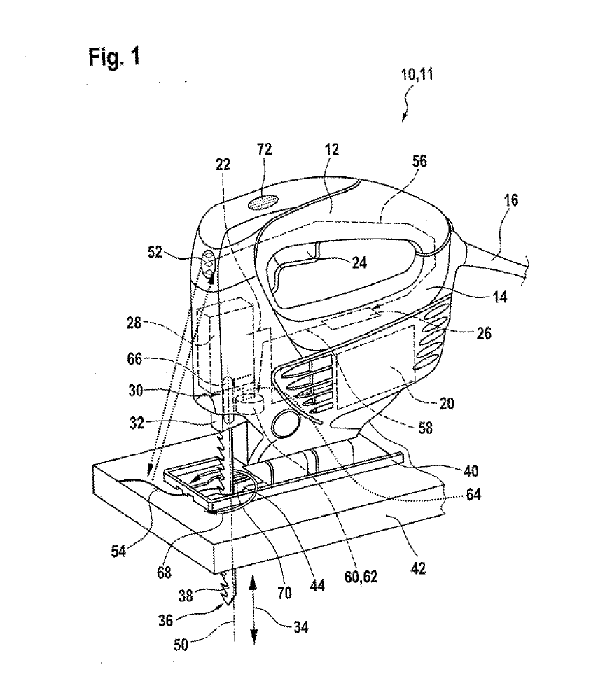

FIG. 1 illustrates a hand tool machine 10 that is embodied in an exemplary manner in the form of a semi-autonomous jig saw 11 and comprises a tool housing 14 that is provided with a loop-type handle grip 12. The semi-autonomous jig saw 11 is equipped with a flexible electrical connection line 16 for the purpose of supplying energy from a mains supply. However, reference is made to the fact that the present disclosure is not limited to a semi-autonomous jig saw 11 that is operated with energy from a mains supply but rather, on the contrary, said disclosure can also be used in jig saws of all types that are not operated with energy from a mains supply and that can be connected for example in a mechanical and electrical manner to an allocated rechargeable battery pack for the purpose of supplying energy.

By way of example, a drive motor 20 that drives a drive shaft 22 is accommodated in the tool housing 14. The drive motor 20 can be actuated for example by way of a manual switch 24 or rather a button by the operator, in other words said drive motor can be switched at least on and off, and can be a motor of any type, for example an electronically commutated motor or a direct current motor. It is preferred that the drive motor 20 can be controlled or rather regulated electronically by way of an electronic control unit 26 in such a manner that for example it is possible, for example, to achieve parameters with respect to a desired rotational speed of the drive shaft 22. As a consequence, the rotational speed of the drive motor 20 and a corresponding saw speed that is associated therewith can be easily adjusted to suit different workpiece characteristics. The mode of operation and the construction of a drive motor of this type 20 and also of the electronic control unit 26 are sufficiently known from the prior art so that for the purpose of brevity of the description a detailed description is omitted.

The drive shaft 22 is mechanically coupled to a reciprocating drive mechanism 28 for the purpose of driving a reciprocating unit 30 that comprises by way of example a tool receiving device 32 for the purpose of clamping an application tool 36 that is driven in a reciprocating manner essentially in the direction of a double arrow 34 by means of the reciprocating drive mechanism 28 or rather said reciprocating unit is connected to said tool receiving device. The application tool 36 is embodied in this case merely in an exemplary manner as a saw blade 38. Said saw blade extends in this case in a perpendicular manner with respect to a foot plate 40 that is fastened to the tool housing 14, wherein the jig saw 11 is placed or rather is guided on said workpiece by means of said foot plate on an exemplary planar work piece 42 or rather said jig saw. The saw blade 38 illustratively engages the work piece 42 through a cutout 44 that is provided in the foot plate 40. As an alternative to the illustrated perpendicular alignment of the saw blade 38 or rather as an alternative to a vertical axis 50 of the saw blade 38 with regard to the workpiece 42, the footplate 40 can be adjusted to an angle of 90° with respect to the vertical axis 50 in order to render it also possible, for example, to perform inclined saw cuts in a simple manner.

An optoelectronic system 52 is integrated in the tool housing 14 by way of example above the reciprocating drive mechanism 28, wherein it is possible in a non-contact manner, by way of example with the aid of an infrared laser beam or the like that is exiting at the front, by means of said optoelectronic system to detect with a high degree of accuracy a progression of a marker line 54 that has been marked out previously on the workpiece 42. A signal 56 that is generated by the optoelectronic system 52 is transmitted preferably at least to the electronic control unit 26. The electronic control unit 26 evaluates and also suitably further processes the signal 56 that originates from the optoelectronic system 52 to produce an output signal 58 that is suitable preferably for the purpose of directly controlling an actuator 60 of an electric actuator system 62.

It is possible to drive an actuating element 64 by means of the preferred electric actuator 60 as part of the electric actuator system 62, wherein said actuating element is embodied for the purpose of pivoting a locking element 66 of the tool receiving device 32 about the vertical axis 50. As a consequence, the saw blade 38 —as indicated by means of the double arrow 68—is pivoted in dependence upon the signal 56 from the optoelectronic system 52 in both directions of rotation about the vertical axis 50 or rather its longitudinal axis so that the saw blade 38 is guided during the semi-autonomous sawing operation constantly precisely along the progression of the marker line 54 and a saw cut 70 that is generated by means of the semi-autonomous jig saw 11 extends with a high degree of accuracy along the predetermined marker line 54. As a consequence, even an untrained operator of the semi-autonomous jig saw 11 is also able to introduce saw cuts 70 into the workpiece 42 with any user-defined progression and with an extremely high degree of accuracy.

During the semi-autonomous sawing operation, an angular range of pivot of the locking element 66 about the vertical axis 50 is not exceeded under any circumstances so that it is fundamentally not possible to unintentionally unlock the saw blade 38 when the drive motor 20 is running and all the requirements with regard to safety when using the semi-autonomous jig saw 11 are fulfilled. Only by virtue of actuating a separate electric switching element 72, in particular a button or a switch, when the drive motor 20 is completely at a standstill is the pivot angle of the saw blade 38 about its vertical axis 50 increased to beyond the normal pivot angle of the semi-autonomous sawing operation to such an extent that it is possible for an operator in a comfortable electric manner to unlock the saw blade 38 and where necessary also to (re-)lock said saw blade in the tool receiving device 32 in an at least in part automatic manner. Where necessary, additional magnetic components can be provided that render it possible to automatically (re-)lock the locking element 66 once the saw blade 38 has been inserted into the tool receiving device 32. It is incumbent upon the electronic control unit 26 preferably at least:
to evaluate the signal 56 that is delivered by the optoelectronic system 52,
to control the electric actuator system 62 for the purpose of adjusting the angle of the saw blade 38 or rather the rotation of said saw blade about its vertical axis 50 for the purpose of unlocking the locking element 66 of the tool receiving device,
to monitor if the drive motor 20 is at a standstill and also to monitor the rotational speed of said drive motor in dependence upon the position of the manual switch 24.

The actuator 60 that is already provided for the purpose of “steering the saw blade” is also used, above all in the case of the semi-autonomous jig saw 11, to electrically unlock the saw blade 38 that is received in the tool receiving device 32. However, regardless of this, the disclosure can also be used in an advantageous manner with conventional jig saws, in other words in particular with non-semi-autonomous jig saws, since costly housing feedthroughs—by way of which foreign particles that could reduce the serviceable life can pass into the interior of the machine—and mechanical actuating elements that consume space and increase the weight for the purpose of operating the locking elements 66 in order to unlock and where necessary (re-)lock the saw blade 38 in the tool receiving device 32 can be omitted without having to provide a substitute.

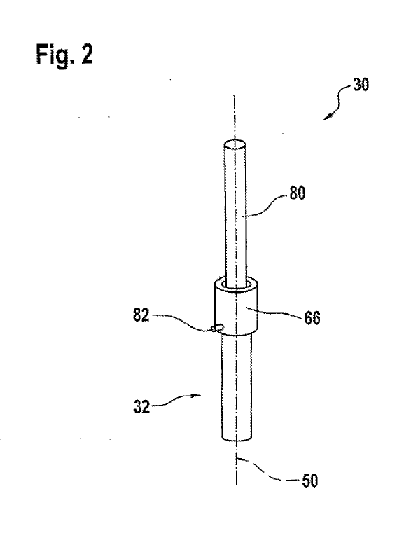

FIG. 2 illustrates the reciprocating unit 30 shown in FIG. 1 that illustratively comprises at least one reciprocating rod 80 that is mechanically coupled to the reciprocating drive mechanism 28 shown in FIG. 1. Said reciprocating rod is by way of example encompassed in a coaxial manner by the locking element 66 of the tool receiving device 32, wherein an actuating pin 82 is embodied on the locking element 66 for the purpose of pivoting the locking element 66 about the vertical axis 50. The actuating pin 82 is embodied in a radial manner aligned towards the exterior on the locking element 66.

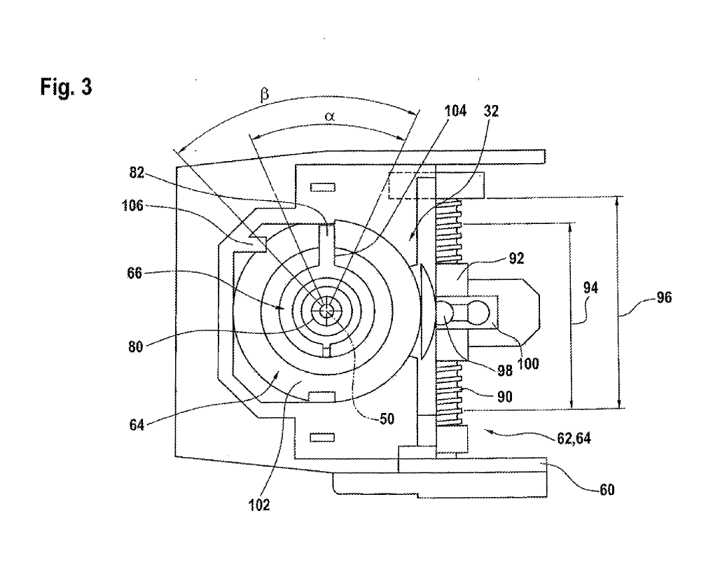

FIG. 3 illustrates the electric actuator system 62 that is shown in FIG. 1 and is embodied in accordance with a first embodiment. Said electric actuator system comprises at least the actuator 60 that illustratively is embodied for the purpose of setting the drive shaft 90 into rotation. A sliding element 92 is received on the drive shaft 90 by means of an inner thread that is formed in a manner that corresponds to the drive shaft 90 so that the sliding element 92 can move in corresponding slide regions 94, 96 backwards and forwards in a linear manner as a result of the rotation of the drive shaft 90.

Moreover, a cylindrical, perpendicular spigot 98 that protrudes out of the plane of the drawing is provided on the sliding element 92 and said spigot engages an almost oval connecting rod 100 of a rotary cage 102. The rotary cage 102 has a narrow, gap-shaped cutout 104, wherein the actuating pin 82 shown in FIG. 2 of the locking element 66 can be introduced into said cutout in a preferably clearance-free manner. Consequently, the rotary cage 102 and as a result the locking element 66 of the tool receiving device 32 are pivoted about the vertical axis 50 by virtue of switching on the actuator 60.

The shorter slide region 94—in FIG. 3—corresponds to a maximum angular range α about which the saw blade 38 shown in FIG. 1 can be pivoted about the vertical axis 50 when the jig saw (11 shown in FIG. 1) is operated in the semi-autonomous sawing operation so that the saw blade is guided with a high degree of precision constantly automatically or rather in a semi-autonomous manner along the indicated marker line 54 shown in FIG. 1, whereas the saw blade or rather the application tool is unlocked in the larger angular range B that continues beyond the angular range α. The longer slide region 96 therefore corresponds with a position in which the locking element 66 is unlocked and in which position the saw blade 38 shown in FIG. 1 can be removed by an operator in a safe manner from the tool receiving device 32 or rather said saw blade falls out of the said tool receiving device automatically so that a different saw blade can be inserted into the tool receiving device 32. When the saw is operated in the semi-autonomous manner, the electronic control unit 26 shown in FIG. 1 ensures that the sliding element 92 does not exceed the shorter slide region 94 under any circumstances so that the saw blade 38 shown in FIG. 1 is prevented from being unlocked in an uncontrolled manner especially when the drive motor 20 shown in FIG. 1 of the jig saw 11 shown in FIG. 1 is running, and any risk to an operator as a result of such uncontrolled opening is reliably prevented.

When the drive motor 20 shown in FIG. 1 is stationary, it is possible by virtue of actuating the electric switching element 72 shown in FIG. 1 for an operator to move the sliding element 92 as far as into the region of the longer slide region 96, as a consequence of which the locking element 66 can be actuated in a comfortable manner and consequently it is possible to unlock the saw blade 38 shown in FIG. 1 from the tool receiving device 32 without the use of a tool. A mechanical stop 106 that is illustratively embodied in a rectangular-shaped manner is used in this case as a travel limiter or rather as an end stop for the actuating pin 82.

The drive of the linear sliding element 92 by means of the (threaded) drive shaft 90 renders it possible in conjunction with the connecting rod 100 of the rotary cage 102 to generate in particular highly mechanical actuating torques for the locking element 66 of the tool receiving device 32. In addition, any mechanical retroactive effect of the locking element 66 on the actuator 60 of the electric actuator system 62 as a result of the self-locking effect of the drive mechanism that is formed by the drive shaft 90, the sliding element 92 and the connecting rod 100 is prevented.

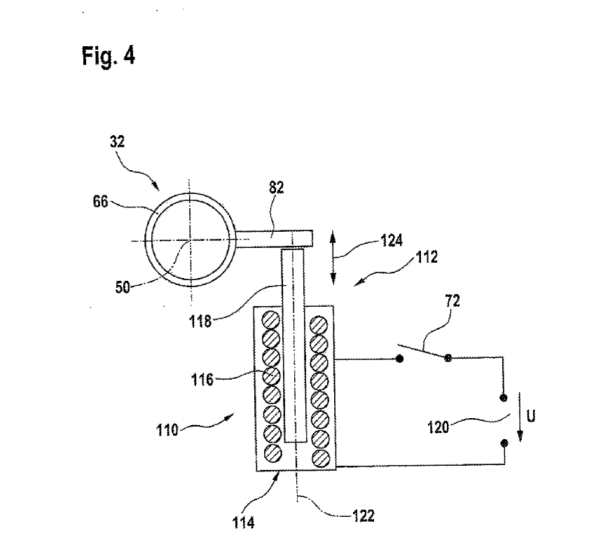

FIG. 4 illustrates a second embodiment of an electric actuator system 110 for the purpose of driving an actuating element 112 in order to unlock and/or (re-)lock the locking element 66 of the tool receiving device 32 shown in FIG. 1 that can be used in lieu of the electric actuator system 62 shown in FIG. 1. This electric actuator system 110 comprises by way of example at least one linear magnet 114 that can be actuated for example by way of the switching element 72 shown in FIG. 1 and that comprises a cylindrical coil 116 which receives an armature 118 in a longitudinal displaceable manner. The cylindrical coil 116 of the linear magnetic 114 is connected by way of the electric switching element 72 to a voltage source 120.

In order to unlock the saw blade (38 in FIG. 1), an operator actuates the switching element 72 shown in FIG. 1, as a consequence of which the linear magnet 114 is supplied with energy and the armature 118 moves in a manner parallel to its longitudinal center axis 122 out of the coil 116. As a result of the armature 118 that abuts against the actuating pin (82 in FIG. 2), the actuating pin of the locking element 66 is pivoted in an anti-clockwise direction about the vertical axis 50 out of the position illustrated in FIG. 4 during the semi-autonomous sawing operation and the saw blade (38 in FIG. 1) is unlocked in a comfortable manner so that a saw blade that has been greatly heated on a number of occasions can be replaced in a contact-less manner without the use of a tool and without the risk of an operator being burnt.

By virtue of re-opening the electric switching element 72 shown in FIG. 1, it is possible to connect the linear magnet 114 in a currentless manner, as a consequence of which the armature 118 is moved back into the coil 116 and the locking element 66 is moved back into its locking position in which the saw blade (38 in FIG. 1) is locked fixedly to the tool receiving device 32 for the semi-autonomous sawing operation. By virtue of supplying energy to the linear magnet 114 and by connecting said linear magnet in a currentless manner, it is possible in this manner to move the armature 118 in both directions of a double arrow 124 out of the coil 116 and back into said coil. In order to support the moving back in or rather the drawing back in of the armature 118 in the case of a currentless coil 116, it is possible to provide suitable resilient elements.

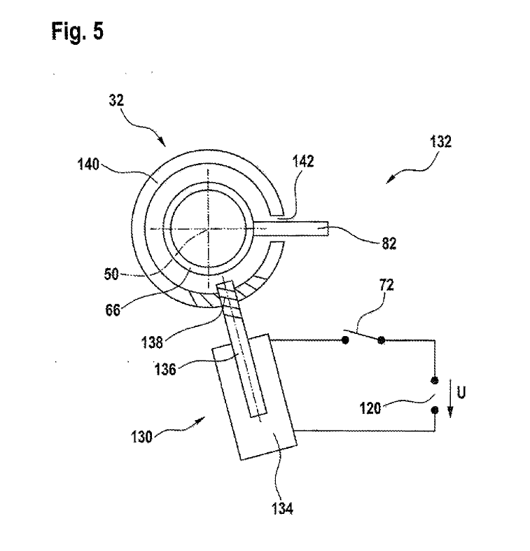

FIG. 5 illustrates a third embodiment of the electric actuator system 130 for the purpose of driving an actuating element 132 in order to unlock and/or (re-)lock the locking element 66 of the tool receiving device 32 shown in FIG. 1, said third embodiment of the electric actuator system can be used in lieu of the electric actuator system 62 shown in FIG. 1 or rather 110 shown in FIG. 4. Said electric actuator system comprises at least one actuator 134 for the purpose of driving a drive shaft 136, wherein a sprocket 138 is arranged on the end of said drive shaft and said sprocket engages in a toothed ring 140 that comprises a gap-shaped cutout 142 for the purpose of receiving the actuating pin 82 shown in FIG. 2 preferably in a clearance-free manner. The actuator 134 is supplied with energy by virtue of the fact that the electric switching element 72 shown in FIG. 1 is closed and as a consequence of said actuator being supplied with current the toothed ring 140 rotates about the vertical axis 50. By virtue of changing the pole of the actuator 134, the direction of movement of the toothed ring 140 and consequently the pivot direction of the actuating pin 82 shown in FIG. 2 are reversed so that the locking element 66 of the tool receiving device 32 shown in FIG. 1 can be rotated in both directions of rotation about the vertical axis 50. This renders it possible during the course of changing the saw blade to unlock and where necessary to (re-)lock the locking element 66 of the tool receiving device 32 shown in FIG. 1.

It is of particular importance in the case of all variants of embodiments of the electric actuator system in accordance with FIGS. 3 to 5, that it is only possible to actuate said electric actuator systems for reasons of safety when the drive motor is completely stationary and this is ensured with the aid of a correspondingly embodied electronic control unit (cf. FIG. 1) under all feasible conditions of use of the jig saw.

What is claimed is:

1. A hand tool machine comprising:
a tool receiving device configured to receive an application tool, the tool receiving device allocated a mechanically actuated locking element configured to lock the application tool in the hand tool receiving device; and
an electric actuator system configured to mechanically actuate the locking element.

2. The hand tool machine according to claim 1, wherein the electric actuator system includes an actuator configured to drive an actuating element configured to actuate the locking element in a mechanical manner.

3. The hand tool machine according to claim 2, wherein the actuator is configured to drive the actuating element in a rotating manner.

4. The hand tool machine according to claim 3, wherein the actuating element includes:
a drive shaft configured to be driven by the actuator; and
a sliding element configured to be actuated by the drive shaft.

5. The hand tool machine according to claim 2, wherein the actuator is configured to drive the actuating element in a linear manner.

6. The hand tool machine according to claim 2, wherein the actuating element is configured to be driven by one of a hydraulically operated slave cylinder, a membrane, and a linear magnet.

7. The hand tool machine according to claim 2, wherein one of the actuator and the linear magnet is configured to be controlled in dependence upon an electric switching element.

8. The hand tool machine according to claim 1, further comprising:
a drive motor configured to drive the tool receiving device,
wherein the locking element is configured to be actuated in a mechanical manner by the electric actuator system only when the drive motor is inactive.

9. The hand tool machine according to claim 1, wherein the hand tool machine is a jig saw.

10. The hand tool machine according to claim 9, wherein:
the jig saw is a semi-autonomous jig saw,
the tool receiving device is configured to be rotated about a vertical axis by the electric actuator system in response to a signal from an optoelectronic system to automatically align the application tool, which is a saw blade, when sawing along on a marker line previously marked out in a predetermined angular range in one saw position.

11. The hand tool machine according to claim 7, wherein the electric switching element is one of a button and a switch.
